(19) United States
(12) Patent Application Publication
(10) Pub. No.: US 2023/0146933 A1
(43) Pub. Date: May 11, 2023

(54) LARGE DEEP LEARNING MODEL TRAINING METHOD AND SYSTEM, DEVICE AND MEDIUM

(71) Applicant: INSPUR SUZHOU INTELLIGENT TECHNOLOGY CO., LTD., Suzhou, Jiangsu (CN)

(72) Inventors: Lianshui ZHAO, Suzhou, Jiangsu (CN); Shachua WU, Suzhou, Jiangsu (CN)

(21) Appl. No.: 17/919,312

(22) PCT Filed: Jan. 25, 2021
(86) PCT No.: PCT/CN2021/073654

§ 371 Date: Oct. 17, 2022

(30) Foreign Application Priority Data
Apr. 16, 2020 (CN) 202010297962.3

(51) Int. Cl. G06N 3/10; G06F 9/50

(52) U.S. Cl. CPC G06N 3/10; G06F 9/5027; G06F 9/5016

(57) ABSTRACT

A deep learning model training method and system, a device, and a storage medium, includes performing the following steps on each topological layer: arranging tensors in an ascending order according to series numbers of topological layers where the tensors are required; sequentially moving the tensors to a Graphics Processing Unit (GPU) according to the arrangement, and determining whether a sum of the tensors already moved to the GPU exceeds a threshold; in response to the fact that the sum of the tensors already moved to the GPU exceeds the threshold, moving the excess part to a Central Processing Unit (CPU), and determining whether the current topological layer is a last topological layer; and in response to the fact that the current topological layer is the last topological layer, correcting a tensor with a positional anomaly.

This application claims priority to Chinese Patent Application No. 202010297962.3, filed on Apr. 16, 2020, in China National Intellectual Property Administration and entitled “Large Deep Learning Model Training Method and System, Device, and Medium”, the contents of which are hereby incorporated by reference in its entirety.

### FIELD

The present disclosure relates to the field of deep learning, and more particularly to a large deep learning model training method and system, a computer device, and a readable medium.

### BACKGROUND

Graphics Processing Unit (GPU) plays an increasingly important role in large deep learning model training. This is mainly because it is suitable for highly parallel computing in large model training and training with a GPU consumes less energy than training with a Central Processing Unit (CPU). However, large deep learning models become more and more structurally complex, and require increasingly large memories beyond existing memory specifications of commercial GPUs. As a result, large deep learning models may not be trained on GPUs, and benefits brought by training with GPUs get meaningless.

In order to reduce the impact of current memory shortage of commercial GPUs, it is proposed to store tensors in the GPU by use of an abundant CPU memory. In large model training, unneeded tensors are moved from the GPU to the CPU, and needed tensors are moved from the CPU to the GPU at the right time. In order to maintain higher performance as much as possible, when the tensors are moved from the CPU back to the GPU, the carrying process is hidden in computation as much as possible to ensure that the needed tensors have been moved to the GPU before use. The existing solution has the following several shortcomings.

(1) A movement strategy is too rough, and all tensors are moved based on the same movement strategy. There is room for improvement of training performance.

(2) There may be a large number of parallel computable operations in the same topological layer in a computational graph, so a memory requirement may exceed a GPU memory. This condition is not considered in the existing solution.

(3) There may be multiple copies of some tensors in the GPU. This condition is also not considered in the existing solution.

### SUMMARY

In view of this, an objective of embodiments of the present disclosure is to disclose a large deep learning model training method and system, a computer device, and a computer-readable storage medium. A more precise and accurate movement strategy is formulated depending on a precedence relationship of using tensors. The tensors are limited not to be moved to a GPU prematurely, so as to reduce the adverse impact brought by memory fragments. Operations in the same topological layer are reallocated to solve the problem of memory shortage caused by excessive parallel computing while ensuring maximum parallelism of each topological layer. The strategy that previous copies have been all used before the tensors are moved to the GPU is formulated, so as to solve the problem of excessive use of a GPU memory.

Based on the above objective, an aspect of the embodiments of the present disclosure provides a large deep learning model training method, including the following steps: arranging tensors in an ascending order according to series numbers of topological layers where the tensors are required; sequentially moving the tensors to a GPU according to the arrangement, and determining whether a sum of the tensors already moved to the GPU exceeds a threshold; in response to the fact that the sum of the tensors already moved to the GPU exceeds the threshold, moving the excess part to a CPU, and determining whether a current topological layer is a last topological layer; and in response to the fact that the current topological layer is the last topological layer, correcting a tensor with a positional anomaly.

In some embodiments, the correcting a tensor with a positional anomaly includes: determining whether there is any tensor with a positional anomaly in the GPU; in response to the fact that there is a tensor with a positional anomaly in the GPU, deleting the tensor, and determining whether there is any tensor with a positional anomaly in the CPU; and in response to the fact that there is a tensor with a positional anomaly in the CPU, moving the tensor to the GPU.

In some embodiments, the method further includes: in response to the fact that there is no tensor with a positional anomaly in the GPU, determining whether a memory required by the topological layer exceeds a memory capacity of the GPU; and in response to the fact that the memory required by the topological layer exceeds the memory capacity of the GPU, reallocating operations in the topological layer.

In some embodiments, the reallocating operations in the topological layer includes: creating a new topological layer, and transferring an operation beyond the memory capacity of the GPU in the original topological layer and an operation unassociated with the operation beyond the memory capacity of the GPU in a next topological layer to the new topological layer.

A further aspect of the embodiments of the present disclosure also provides a large deep learning model training system, including: an ordering module, configured to arrange tensors in an ascending order according to series numbers of topological layers where the tensors are required; a first determination module, configured to sequentially move the tensors to a GPU according to the arrangement, and determine whether a sum of the tensors already moved to the GPU exceeds a threshold; a second determination module, configured to, in response to the fact that the sum of the tensors already moved to the GPU exceeds the threshold, move the excess part to a CPU, and determine whether a current topological layer is a last topological layer; and a correction module, configured to, in response to the fact that the current topological layer is the last topological layer, correct a tensor with a positional anomaly.

In some embodiments, the correction module is further configured to: determine whether there is any tensor with a positional anomaly in the GPU; in response to the fact that there is a tensor with a positional anomaly in the GPU, delete the tensor, and determine whether there is any tensor with a positional anomaly in the CPU; and in response to the fact that there is a tensor with a positional anomaly in the CPU, move the tensor to the GPU.

In some embodiments, the system further includes a third determination module, configured to, in response to the fact that there is no tensor with a positional anomaly in the GPU, determine whether a memory required by the topological layer exceeds a memory capacity of the GPU, and in response to the fact that the memory required by the topological layer exceeds the memory capacity of the GPU, reallocate operations in the topological layer.

In some embodiments, the third determination module is further configured to create a new topological layer, and transfer an operation beyond the memory capacity of the GPU in the original topological layer and an operation unassociated with the operation beyond the memory capacity of the GPU in a next topological layer to the new topological layer.

A further aspect of the embodiments of the present disclosure also provides a computer device, including: at least one processor; and a storage device, storing a computer instruction executable by the processor, wherein the instruction is executed by the processor to implement the steps of the above method.

A further aspect of the embodiments of the present disclosure also provides a computer-readable storage medium, storing a computer program that is executed by a processor to implement the steps of the above method.

The present disclosure has the following beneficial effects. A more precise and accurate movement strategy is formulated depending on a precedence relationship of using the tensors. The tensors are limited not to be moved to the GPU prematurely, so as to reduce the adverse impact brought by memory fragments. Operations in the same topological layer are reallocated to solve the problem of memory shortage caused by excessive parallel computing while ensuring maximum parallelism of each topological layer. The strategy that previous copies have been all used before the tensors are moved to the GPU is formulated, so as to solve the problem of excessive use of a GPU memory.

### BRIEF DESCRIPTION OF THE DRAWINGS

In order to describe the technical solutions in the embodiments of the present disclosure or the prior art more clearly, the drawings required to be used in descriptions about the embodiments or the prior art will be introduced briefly below. Apparently, the drawings in the description below are only some embodiments of the present disclosure. Those ordinarily skilled in the art may further obtain other embodiments according to these drawings without creative work.

FIG. 1 is a schematic diagram of an embodiment of a large deep learning model training method according to the present disclosure;

FIG. 2 is a schematic diagram of reallocating operations in a topological layer in an embodiment of a large deep learning model training method according to the present disclosure;

FIG. 3 is a schematic diagram of a hardware structure of an embodiment of a computer device for a large deep learning model training according to the present disclosure;

FIG. 4 is a schematic diagram of an embodiment of a large deep learning model training system according to the present disclosure; and

FIG. 5 is a schematic diagram of a computer-readable storage medium according to the present disclosure.

### DETAILED DESCRIPTION

In order to make the objective, technical solutions, and advantages of the present disclosure clearer, the embodiments of the present disclosure will further be described below in detail in combination with specific embodiments and with reference to the drawings.

It is to be noted that all expressions made with “first”, “second”, etc., in the embodiments of the present disclosure are for distinguishing two different entities or parameters with the same name, and thus it can be seen that “first” and “second” are only for ease of description and should not be understood as limitations on the embodiments of the present disclosure. No descriptions are made thereto in the following embodiments.

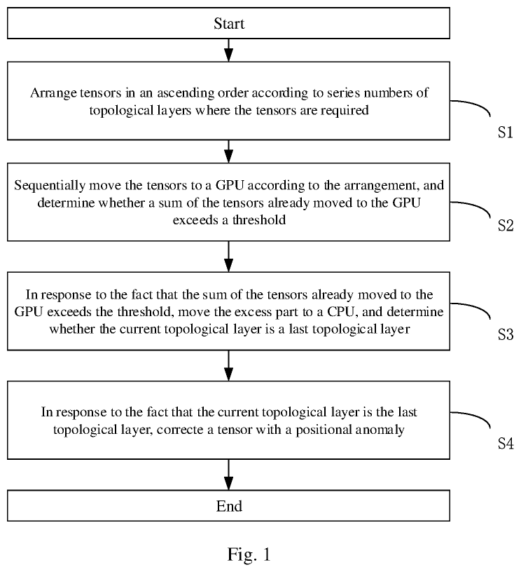

Based on the above objective, a first aspect of the embodiments of the present disclosure discloses an embodiment of a large deep learning model training method. FIG. 1 is a schematic diagram of an embodiment of a large deep learning model training method according to the present disclosure. As shown in FIG. 1, the embodiment of the present disclosure includes the following steps.

In S1, tensors are arranged in an ascending order according to series numbers of topological layers where the tensors are required.

In S2, the tensors are sequentially moved to a GPU according to the arrangement, and whether a sum of the tensors already moved to the GPU exceeds a threshold is determined.

In S3, in response to the fact that the sum of the tensors already moved to the GPU exceeds the threshold, the excess part is moved to a CPU, and whether the current topological layer is a last topological layer is determined.

In S4, in response to the fact that the current topological layer is the last topological layer, a tensor with a positional anomaly is corrected.

Tensors are arranged in an ascending order according to series numbers of topological layers where the tensors are required. For example, a first topological layer where tensor a is required is 6, a first topological layer where tensor b is required is 11, a first topological layer where tensor c is required is 13, and a first topological layer where tensor d is required is 15. In such case, an arrangement order of the tensors is a, b, c, d.

The tensors are sequentially moved to a GPU according to the order, and whether a sum of the tensors already moved to the GPU exceeds a threshold is determined. The tensors are sequentially moved to the GPU according to the order of a, b, c, d, and whether the sum of the tensors already moved to the GPU exceeds the threshold is determined in real time. The threshold may be, for example, 10 GB, a size of tensor a is 4 GB, a size of tensor b is 3 GB, a size of tensor c is 4 GB, and a size of tensor d is 3 GB. If tensor a and tensor b are moved to the GPU, because of 4+3<10, the sum of the tensors already moved to the GPU does not exceed the threshold. However, if tensor c is moved to the GPU furtherly, because of 4+3+4>10, the sum of the tensors already moved to the GPU exceeds the threshold.

In response to the fact that the sum of the tensors already moved to the GPU exceeds the threshold, the excess part is moved to a CPU, and whether the current topological layer is a last topological layer is determined. In the above example, the sum of the tensors already moved to the GPU exceeds the threshold if tensor c is moved to the GPU together, tensor c and tensor d may be moved to the CPU. In addition, whether the current topological layer is the last topological layer is determined.

In response to the fact that the current topological layer is the last topological layer, a tensor with a positional anomaly is corrected. The step that a tensor with a positional anomaly is corrected includes that: whether there is any tensor with a positional anomaly in the GPU is determined; in response to the fact that there is a tensor with a positional anomaly in the GPU, the tensor is deleted, and whether there is any tensor with a positional anomaly in the CPU is determined; and in response to the fact that there is a tensor with a positional anomaly in the CPU, the tensor is moved to the GPU.

In some embodiments, the step that whether there is any tensor with a positional anomaly in the GPU is determined includes that: whether a position of the tensor in a next topological layer is in the CPU is determined. Positions of the same tensor in different topological layers may be different. For example, when tensor c is generated in layer 4, and a next topological layer where the tensor is required is 11, it is found by computing that tensor c is in the CPU in layers 6 and 8, and is in the GPU in layers 5, 7, 9, and 10. By this method, it is ensured that a tensor is more likely to be in the GPU when being closer to a layer where it is required, and the tensor needs to be arranged in the GPU in a previous layer of the layer where it is required. A standard for determining whether a position of a tensor is wrong is that it is currently in the GPU but a next position thereof is in the CPU, such as layers 5 and 7. From the above determined tensor positions, tensor c actually needs to be in the GPU in layers 9 and 10, and in layers 4, 5, and 7, tensor c needs to be in the CPU, but is regarded as being in the GPU, which is inconsistent with the actual situation. Therefore, tensor c is a tensor with a positional anomaly.

In response to the fact that there is a tensor with a positional anomaly in the GPU, the tensor is deleted, and whether there is any tensor with a positional anomaly in the CPU is determined. A basis for determining that a position of a tensor in the GPU may be earlier is that it is currently in the CPU but its next position is in the GPU, such as layers 6 and 8.

In response to the fact that there is a tensor with a positional anomaly in the CPU, the tensor is moved to the GPU. If there is a space in the GPU, and there is a tensor with a positional anomaly in the CPU, the tensor may be moved to the GPU.

There are many factors that affect the training performance, including not only whether tensors may be timely moved to the GPU but also whether an acceleration library in a Compute Unified Device Architecture (CUDA) (GPU-based computing platform launched by NVIDIA) Deep Neural Network (cuDNN) library of NVIDIA is fully used. If the tensors are moved to the GPU prematurely, it is likely to generate excessive memory fragments in the GPU, which makes an actual training process unstable. In addition, a spare memory in the GPU is very limited, which is not conducive to application of a faster algorithm in the cuDNN, reducing the performance. Analysis on a large number of experimental results show that setting time of moving the tensors back to the GPU to be not earlier than first 100 topological layers where the tensors are required may generally achieve relatively high performance.

In some embodiments, in response to the fact that there is no tensor with a positional anomaly in the GPU, whether a memory required by the topological layer exceeds a memory capacity of the GPU is determined. In response to the fact that the memory required by the topological layer exceeds the memory capacity of the GPU, operations in the topological layer are reallocated. In a computational graph, parallel computing may be performed for operations in each topological layer. However, if there are many parallel computations at the same time, a required memory may exceed a memory capacity of the GPU, and thus there may be brought the problem that a model may not be trained on the GPU. In order to solve the problem of excessive memory requirement of parallel computing, maximum allowed parallelism of each topological layer may be controlled to make the memory requirement not higher than a certain threshold.

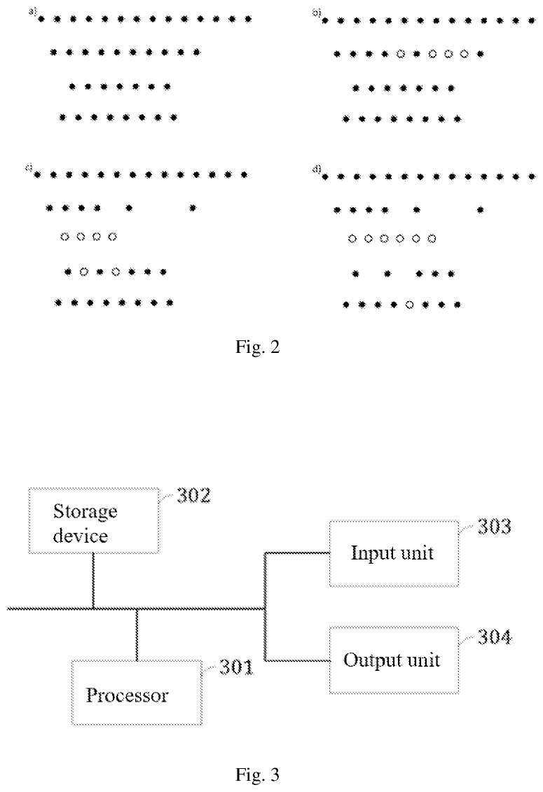

In some embodiments, the step that operations in the topological layer are reallocated includes that: a new topological layer is created, and an operation beyond the memory capacity of the GPU in the original topological layer and an operation unassociated with the operation beyond the memory capacity of the GPU in a next topological layer are moved to the new topological layer. FIG. 2 is a schematic diagram of reallocating operations in a topological layer. As shown in FIG. 2, a) shows original topological layers of a computational graph, wherein all black nodes in each layer represent parallel computable operations. It is found by memory computing that parallel computing of the first layer does not exceed a set threshold, and thus parallelism of the first layer needs not to be reallocated. When the second layer is computed, it is found that only part of operations may be retained in the second layer, such as black nodes in the second layer in b); and the other four nodes (circles in the second layer) need to be allocated to a new layer, as shown in c), and the four operations are allocated to a new topological layer. In order to achieve maximum parallelism of the new topological layer, operations independent of the previous four operations in the original third layer may be moved to the new topological layer. As shown in c), two operations (circles) in the original third layer are allocated to the new topological layer, as shown in d). Since two operations in the original third layer are allocated to the new topological layer, to achieve maximum parallelism of the third layer, operations independent of the operations in the third layer may be allocated to the third layer. As shown in d), one operation (circle) may be allocated to the third layer. In order to achieve maximum parallelism of each other layer, the above steps may be performed on each layer. At this point, the new topological layer includes six operations. If their memory requirement does not exceed the threshold, the six operations finally form the new topological layer. If their memory requirement exceeds the threshold, the steps for the second layer are performed to implement reallocation.

In the GPU, there may be multiple copies for the same tensor. As a result, the GPU memory is used excessively, which is prone to memory shortage of the GPU. For example, the same tensor is used for operations 1 to 4, but the tensor is moved to the GPU by different actions of movement. If operations 1 to 3 are not completed at the beginning of operation 4, there are two copies of the tensor in the GPU, resulting in excessive use of the GPU memory and even memory shortage. In order to solve this problem, the copy for operation 4 may be forcibly started to be moved to the GPU after operations 1 to 3 are completed.

According to the embodiment of the present disclosure, movement of each tensor is planned according to the idea that a tensor may be moved to the GPU first if being used earlier, whereby maximization of performance is ensured. The tensors are limited not to be moved to a GPU prematurely, so as to reduce the adverse impact brought by memory fragments. The same topological layer is limited to reallocate topological layers with excessive parallel computing while ensuring the maximum parallelism of each topological layer, so as to solve the problem of GPU memory shortage caused by excessive parallel computing in the same topological layer. According to the present disclosure, the measure that previous copies have been all used before the tensors are moved to the GPU is formulated, so as to solve the problem of existence of multiple copies of the same tensor in the GPU and avoid excessive use of the GPU memory.

It is to be particularly pointed out that the steps in each embodiment of the large deep learning model training method may be mutually intersected, replaced, added, and deleted. Therefore, these reasonable permutations, combinations, and transformations about the large deep learning model training method shall also fall within the scope of protection of the present disclosure, and the scope of protection of the present disclosure should not be limited to the embodiments.

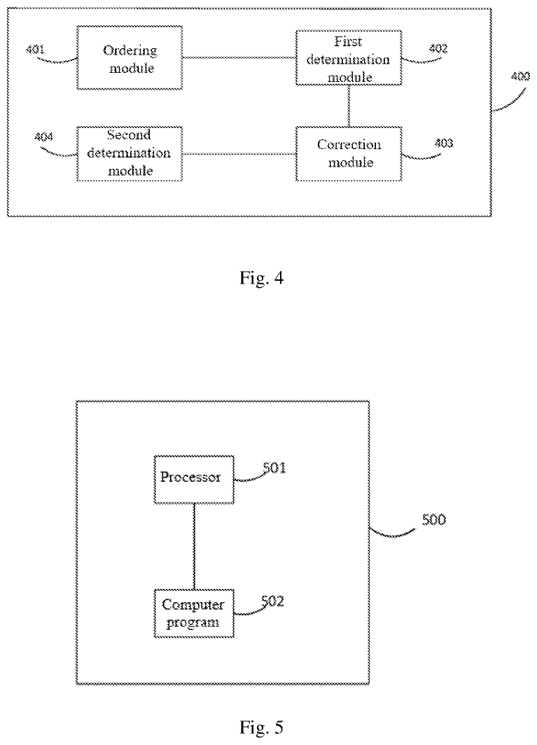

Based on the above objective, a second aspect of the embodiments of the present disclosure discloses a large deep learning model training system 400, as shown in FIG. 4, including: an ordering module 401, configured to arrange tensors in an ascending order according to series numbers of topological layers where the tensors are required; a first determination module 402, configured to sequentially move the tensors to a GPU according to the arrangement, and determine whether a sum of the tensors already moved to the GPU exceeds a threshold; a second determination module 403, configured to, in response to the fact that the sum of the tensors already moved to the GPU exceeds the threshold, move the excess part to a CPU, and determine whether a current topological layer is a last topological layer; and a correction module 404, configured to, in response to the fact that the current topological layer is the last topological layer, correct a tensor with a positional anomaly.

In some embodiments, the correction module 404 is further configured to: determine whether there is any tensor with a positional anomaly in the GPU; in response to the fact that there is a tensor with a positional anomaly in the GPU, delete the tensor, and determine whether there is any tensor with a positional anomaly in the CPU; and in response to the fact that there is a tensor with a positional anomaly in the CPU, move the tensor to the GPU.

In some embodiments, the system 400 further includes a third determination module, configured to, in response to the fact that there is no tensor with a positional anomaly in the GPU, determine whether a memory required by the topological layer exceeds a memory capacity of the GPU, and in response to the fact that the memory required by the topological layer exceeds the memory capacity of the GPU, reallocate operations in the topological layer.

In some embodiments, the third determination module is further configured to create a new topological layer, and transfer an operation beyond the memory capacity of the GPU in the original topological layer and an operation unassociated with the operation beyond the memory capacity of the GPU in a next topological layer to the new topological layer.

Based on the above objective, a third aspect of the embodiments of the present disclosure discloses a computer device, including: at least one processor; and a memory, storing a computer instruction capable of running in the processor. The instruction is executed by the processor to implement the following steps: S1: arranging tensors in an ascending order according to series numbers of topological layers where the tensors are required; S2: sequentially moving the tensors to a GPU according to the arrangement, and determining whether a sum of the tensors already moved to the GPU exceeds a threshold; S3: in response to the fact that the sum of the tensors already moved to the GPU exceeds the threshold, moving the excess part to a CPU, and determining whether a current topological layer is a last topological layer; and S4: in response to the fact that the current topological layer is the last topological layer, correcting a tensor with a positional anomaly.

In some embodiments, the correcting a tensor with a positional anomaly includes: determining whether there is any tensor with a positional anomaly in the GPU; in response to the fact that there is a tensor with a positional anomaly in the GPU, deleting the tensor, and determining whether there is any tensor with a positional anomaly in the CPU; and in response to the fact that there is a tensor with a positional anomaly in the CPU, moving the tensor to the GPU.

In some embodiments, the following steps are further included: in response to the fact that there is no tensor with a positional anomaly in the GPU, determining whether a memory required by the topological layer exceeds a memory capacity of the GPU; and in response to the fact that the memory required by the topological layer exceeds the memory capacity of the GPU, reallocating operations in the topological layer.

In some embodiments, the reallocating operations in the topological layer includes: creating a new topological layer, and transferring an operation beyond the memory capacity of the GPU in the original topological layer and an operation unassociated with the operation beyond the memory capacity of the GPU in a next topological layer to the new topological layer.

FIG. 3 is a schematic diagram of a hardware structure of an embodiment of the computer device for large deep learning model training according to the present disclosure.

Taking the device shown in FIG. 3 as an example, the device includes a processor 301 and a storage device 302, and may further include an input unit 303 and an output unit 304.

The processor 301, the storage device 302, the input unit 303, and the output unit 304 may be connected by a bus or other manners. FIG. 3 takes connection by a bus as an example.

As a nonvolatile computer-readable storage medium, the storage device 302 may be used to store a nonvolatile software program, a nonvolatile computer-executable program, and a module, e.g., a program instruction/module corresponding to the large deep learning model training method in the embodiments of the present application. The processor 301 runs the nonvolatile software program, instruction, and module stored in the storage device 302, so as to execute various types of function applications and data processing of a server, namely implementing the large deep learning model training method of the method embodiment.

The storage device 302 may include a program storage region and a data storage region. The program storage region may store an operating system and an application program required by at least one function. The data storage region may store data created according to the use of the large deep learning model training method, etc. In addition, the storage device 302 may include a high-speed Random Access Memory (RAM), or a nonvolatile memory, such as at least one disk storage device, flash storage device, or another volatile solid-state storage device. In some embodiments, the storage device 302 in some embodiments includes a memory arranged remotely relative to the processor 301, and the remote memory may be connected to a local module through a network. Examples of the network include, but not limited to, the Internet, an intranet of an enterprise, a local area network, a mobile communication network, and a combination thereof.

The input unit 303 may receive input information, such as a user name and a password. The output unit 304 may include a display device, such as a display screen.

On or more program instructions/modules corresponding to the large deep learning model training method are stored in the storage device 302, and are executed by the processor 301 to perform the large deep learning model training method in any above-mentioned method embodiment.

In any embodiment of the computer device that performs the large deep learning model training method, effects the same as or similar to those in any corresponding method embodiment may be achieved.

The present disclosure also provides a computer-readable storage medium 500. As shown in FIG. 5, the computer-readable storage medium 500 stores a computer program 502 that is executed by a processor 501 to perform the above method.

It is finally to be noted that those ordinarily skilled in the art can understand that all or part of the processes in the method of the above-mentioned embodiment may be completed by a computer program by instructing related hardware. The program for the large deep learning model training method may be stored in a computer-readable storage medium. When the program is executed, the processes of each method embodiment may be included. The storage medium that stores the program may be a magnetic disk, an optical disk, a Read-Only Memory (ROM), a RAM, etc. The embodiment of the computer program may have effects the same as or similar to those in any corresponding method embodiment.

In addition, the method disclosed according to the embodiments of the present disclosure may also be implemented as a computer program executed by a processor. The computer program may be stored in a computer-readable storage medium. When the computer program is executed by the processor, the functions defined in the method disclosed in the embodiments of the present disclosure are executed.

Moreover, each method step and system unit may also be implemented by a controller and a computer-readable storage medium configured to store a computer program that enables the controller to implement the steps or functions of the units.

Furthermore, it is to be understood that the computer-readable storage medium (such as a memory) herein may be a volatile memory or a nonvolatile memory, or may include both a volatile memory and a nonvolatile memory. As an example rather than restriction, the nonvolatile memory may be a ROM, a Programmable ROM (PROM), an Erasable PROM (EPROM), an Electrically EPROM (EEPROM), or a flash memory. The volatile memory may include a RAM that may be used as an external cache memory. As an example rather than restriction, the RAM may be obtained in various forms, such as a Dynamic RAM (DRAM), a Synchronous DRAM (SDRAM), a Double Data Rate SDRAM (DDR SDRAM), an Enhanced SDRAM (ESDRAM), a Synchronous Link DRAM (SLDRAM), and a Direct Rambus RAM (DRRAM). The storage device in the disclosed aspect is intended to include, but not limited to, these or other proper types of memories. The storage device in the disclosed aspect is intended to include, but not limited to, these or other proper types of memories.

It is also understood by those skilled in the art that various exemplary logic blocks, modules, circuits, and algorithm steps described in combination with the disclosure herein may be implemented as electronic hardware, computer software, or a combination thereof. For ease of description about such interchangeability of hardware and software, functions of various schematic components, blocks, modules, circuits, and steps are described generally. Whether these functions are implemented as software or hardware depends on specific applications and design constraints on the whole system. Those skilled in the art may realize the functions for each specific application in various manners, but such realization should not be explained as resulting in departure from the scope disclosed in the embodiment of the present disclosure.

Various exemplary logical blocks, modules, and circuits described in combination with the disclosure herein may be implemented or executed by the following components designed to execute the functions herein: a general-purpose processor, a Digital Signal Processor (DSP), an Application Specific Integrated Circuit (ASIC), a Field Programmable Gate Array (FPGA) or another programmable logic device, a discrete gate or transistor logic, a discrete hardware component, or any combination thereof. The general-purpose processor may be a microprocessor. Alternatively, the processor may be any conventional processor, controller, microcontroller, or state machine. Alternatively, the processor may be implemented as a combination of computing devices, such as a combination of a DSP and a microprocessor, multiple microprocessors, a combination of one or more microprocessors and a DSP, and/or any other such configuration.

The steps of the method or algorithm described in combination with the disclosure herein may be directly included in hardware, a software module executed by the processor, or a combination thereof. The software module may be located in a RAM, a flash memory, a ROM, an EPROM, an EEPROM, a register, a hard disk, a removable disk, a Compact Disc ROM (CD-ROM), or a storage medium of any other form well known in this art. The storage medium is exemplarily coupled to the processor such that the processor may read information from the storage medium or write information to the storage medium. In an alternative solution, the storage medium may be integrated with the processor. The processor and the storage medium may be located in an ASIC. The ASIC may be located in a user terminal. In an alternative solution, the processor and the storage medium may be located in a user terminal as discrete components.

In one or more exemplary designs, the function may be realized in hardware, software, firmware, or any combination thereof. If being realized in software, the function may be stored in a computer-readable medium or transmitted through the computer-readable medium as one or more instructions or codes. The computer-readable medium includes a computer storage medium and a communication medium. The communication medium includes any medium that helps transmit a computer program from one position to another. The storage medium may be any available medium accessible for a general-purpose or special-purpose computer. As an example rather than restriction, the computer-readable medium may include a RAM, a ROM, an EEPROM, a CD-ROM or another optical disc storage device, a disk storage device or another magnetic storage device, or any other medium available for carrying or storing a needed program code in form of an instruction or a data structure and accessible for a general-purpose or special-purpose computer or a general-purpose or special-purpose processor. In addition, any connection may be referred to as a computer-readable medium as appropriate. For example, if a coaxial cable, a fiber optic cable, a twisted pair, a Digital Subscriber Line (DSL), or a wireless technology like infrared, radio, and microwave is used to send software from a website, a server, or another remote source, the coaxial cable, the fiber optic cable, the twisted pair, the DSL, or the wireless technology like infrared, radio, and microwave is included in the definition of the medium. As used herein, the magnetic disk and the optical disc include a Compact Disc (CD), a laser disc, an optical disc, a Digital Versatile Disc (DVD), a floppy disc, and a blue-ray disc. Generally, the magnetic disk magnetically reproduces data, while the optical disc optically reproduces data using laser. Combinations of the above-mentioned contents should also be included in the scope of the computer-readable medium.

The above is the exemplary embodiment disclosed in the present disclosure. However, it is to be noted that various variations and modifications may be made without departing from the scope defined in the claims and disclosed in the embodiments of the present disclosure. The functions, steps, and/or actions in the method claims according to the disclosed embodiments described herein are not required to be executed in any specific sequence. In addition, the element disclosed in the embodiments of the present disclosure may be described or required in an individual form, but may be understood as a plural form, unless clearly limited to a singular form.

It is to be understood that, as used herein, the singular form “a/an” is intended to include the plural form also, unless exceptional cases are supported clearly in the context. It is also to be understood that “and/or” used herein refers to including any or all possible combinations of one or more than one item that is listed associatively.

The sequence numbers of the embodiments of the present disclosure are only for description and do not represent superiority-inferiority of the embodiments.

It can be understood by those ordinarily skilled in the art that all or part of the steps of the above-mentioned embodiments may be completed by hardware, or by a program by instructing related hardware. The program may be stored in a computer-readable storage medium. The above-mentioned storage medium may be a ROM, a magnetic disk, an optical disk, or the like.

It is to be understood by those ordinarily skilled in the art that discussions about any above embodiment are only exemplary and not intended to imply that the scope (including the claims) disclosed in the embodiments of the present disclosure is limited to these examples. Under the concept of the embodiments of the present disclosure, the above embodiments or technical features in different embodiments may also be combined, and there are many other variations of different aspects of the embodiments of the present disclosure as described above, which are not provided in details for brevity. Therefore, any omissions, modifications, equivalent replacements, improvements, etc., made within the spirit and principle of the embodiments of the present disclosure shall fall within the scope of protection of the embodiments of the present disclosure.

1. A deep earning model training method, comprising performing the following steps on each topological layer:
arranging tensors in an ascending order according to series numbers of topological layers where the tensors are required;
sequentially moving the tensors to a Graphics Processing Unit (GPU) according to the arrangement, and determining whether a sum of the tensors already moved to the GPU exceeds a threshold;
in response to the fact that the sum of the tensors already moved to the GPU exceeds the threshold, moving the excess part to a Central Processing Unit (CPU), and determining whether the current topological layer is a last topological layer; and
in response to the fact that the current topological layer is the last topological layer, correcting a tensor with a positional anomaly.

2. The method according to claim 1, wherein the correcting a tensor with a positional anomaly comprises:
determining whether there is any tensor with a positional anomaly in the GPU;
in response to there being a tensor with a positional anomaly in the GPU, deleting the tensor, and determining whether there is any tensor with a positional anomaly in the CPU; and
in response to there being a tensor with a positional anomaly in the CPU, moving the tensor to the GPU.

3. The method according to claim 2, further comprising:
in response to there being no tensor with a positional anomaly in the GPU, determining whether a memory required by the topological layer exceeds a memory capacity of the GPU; and
in response to the memory required by the topological layer exceeding the memory capacity of the GPU, reallocating operations in the topological layer.

4. The method according to claim 3, wherein the reallocating operations in the topological layer comprises:
creating a new topological layer, and transferring an operation beyond the memory capacity of the GPU in the original topological layer and an operation unassociated with the operation beyond the memory capacity of the GPU in a next topological layer to the new topological layer.

5.-8. (canceled)

9. A computer device, comprising:
at least one processor; and
a storage device, storing a computer instruction executable by the processor, and upon execution by the processor, the computer instruction is configured to cause the processor to perform operations comprising performing the following steps on each topological layer:
arranging tensors in an ascending order according to series numbers of topological layers where the tensors are required;
sequentially moving the tensors to a Graphics Processing Unit (GPU) according to the arrangement, and determining whether a sum of the tensors already moved to the GPU exceeds a threshold;
in response to the sum of the tensors already moved to the GPU exceeds the threshold, moving the excess part to a Central Processing Unit (CPU), and determining whether the current topological layer is a last topological layer; and
in response to the current topological layer is the last topological layer, correcting a tensor with a positional anomaly.

10. A computer-readable storage medium, storing a computer program, and upon execution by a processor, the computer program causes the processor to perform operations comprising performing the following steps on each topological layer:
arranging tensors in an ascending order according to series numbers of topological layers where the tensors are required;
sequentially moving the tensors to a Graphics Processing Unit (GPU) according to the arrangement, and determining whether a sum of the tensors already moved to the GPU exceeds a threshold;
in response to the sum of the tensors already moved to the GPU exceeds the threshold, moving the excess part to a Central Processing Unit (CPU), and determining whether the current topological layer is a last topological layer; and
in response to the current topological layer is the last topological laver, correcting a tensor with a positional anomaly.

11. The computer device according to claim 9, wherein the correcting a tensor with a positional anomaly comprises:
determining whether there is any tensor with a positional anomaly in the GPU;
in response to there being a tensor with a positional anomaly in the GPU, deleting the tensor; and determining whether there is any tensor with a positional anomaly in the CPU; and
in response to there being a tensor with a positional anomaly in the CPU, moving the tensor to the GPU.

12. The computer device according to claim 11, wherein the processor, upon execution of the computer instruction, further performs operations comprising:
in response to there being no tensor with a positional anomaly in the GPU, determining whether a memory required by the topological layer exceeds a memory capacity of the GPU; and
in response to the memory required by the topological layer exceeding the memory capacity of the GPU, reallocating operations in the topological layer.

13. The computer device according to claim 12, wherein the reallocating operations in the topological layer comprises:
creating a new topological layer, and transferring an operation beyond the memory capacity of the GPU in the original topological layer and an operation unassociated with the operation beyond the memory capacity of the GPU in a next topological layer to the new topological layer.

14. The computer-readable storage medium according to claim 10, wherein the correcting a tensor with a positional anomaly comprises:
determining whether there is any tensor with a positional anomaly in the GPU;
in response to there being a tensor with a positional anomaly in the GPU, deleting the tensor, and determining whether there is any tensor with a positional anomaly in the CPU; and
in response to there being a tensor with a positional anomaly in the CPU; moving the tensor to the GPU.

15. The computer-readable storage medium according to claim 14, wherein the processor, upon execution of the computer program, further performs operations comprising:
in response to there being no tensor with a positional anomaly in the GPU, determining whether a memory required by the topological layer exceeds a memory capacity of the GPU; and
in response to the memory required by the topological layer exceeding the memory capacity of the GPU, reallocating operations in the topological layer.

16. The computer-readable storage medium according to claim 15, wherein the reallocating operations in the topological layer comprises:
creating a new topological layer, and transferring an operation beyond the memory capacity of the GPU in the original topological layer and an operation unassociated with the operation beyond the memory capacity of the GPU in a next topological layer to the new topological layer.

17. The method according to claim 2, wherein the determining whether there is any tensor with a positional anomaly in the GPU comprises:
determining whether the tensor is currently in the GPU but a next position thereof is in the CPU.

18. The method according to claim 2, wherein the in response to there being a tensor with a positional anomaly in the CPU, moving the tensor to the GPU comprises:
determining whether there is a space in the GPU; and
in response to there being the space in the GPU and there is a tensor with a positional anomaly in the CPU, moving the tensor to the GPU.

19. The method according to claim 2, wherein the method further comprises:
setting time of moving the tensors back to the GPU to be not earlier than first 100 topological layers where the tensors are required.

20. The computer device according to claim 11, wherein the determining whether there is any tensor with a positional anomaly in the GPU comprises:
determining whether the tensor is currently in the GPU but a next position thereof is in the CPU.

21. The computer device according to claim 11, wherein the in response to there being a tensor with a positional anomaly in the CPU, moving the tensor to the GPU comprises:
determining whether there is a space in the GPU; and
in response to there being the space in the GPU and there is a tensor with a positional anomaly in the CPU, moving the tensor to the GPU.

22. The computer device according to claim 11, wherein the processor, upon execution of the computer instruction, further performs operations comprising:
setting time of moving the tensors back to the GPU to be not earlier than first 100 topological layers where the tensors are required.

23. The computer-readable storage medium according to claim 14, wherein the determining whether there is any tensor with a positional anomaly in the GPU comprises:
determining whether the tensor is currently in the GPU but a next position thereof is in the CPU.

24. The computer-readable storage medium according to claim 14, wherein the in response to there being a tensor with a positional anomaly in the CPU, moving the tensor to the GPU comprises:
determining whether there is a space in the GPU; and
in response to there being the space in the GPU and there is a tensor with a positional anomaly in the CPU, moving the tensor to the GPU.
